(19) United States
(12) Patent Application Publication
(10) Pub. No.: US 2008/0173184 A1
(43) Pub. Date: Jul. 24, 2008

(54) Tea cup device

(76) Inventor: Ying Chien Chang, Taichung (TW)

Correspondence Address: CHARLES E. BAXLEY, ESQ., 90 JOHN STREET, THIRD FLOOR, NEW YORK, NY, 10038, US

(21) Appl. No.: 11/903,548

(22) Filed: Sep. 21, 2007

(30) Foreign Application Priority Data
Jan. 24, 2007 (CN) 200710002502.8

(51) Int. Cl. A47J 31/06

(52) U.S. Cl. 99/298

(57) ABSTRACT

A tea cup device includes a container having a chamber for receiving a tea or other drinkable materials, and a filter device disposed in the container for separating the chamber of the container into two separated compartments, and for receiving the tea in either of the compartments, and for allowing the tea to be completely opened or stretched after disposed in water, and the filter device may block the tea for preventing the tea from flowing into the mouth of the user while drinking the tea. The filter device may completely or partially block the chamber of the container, or may includes one or more screen members coupled together, or may includes a cup-shaped structure.

### BACKGROUND OF THE INVENTION

1. Field of the Invention

The present invention relates to a tea cup device, and more particularly to a tea cup device including a structure for allowing the tea to be completely opened or stretched and for blocking the tea and for preventing the tea from flowing into the mouth of the user while drinking the tea.

2. Description of the Prior Art

Typically, tea is received or contained in a tea caddy or canister and is required to be removed form the tea caddy or canister and disposed into a cup device for making the tea. However, it is inconvenient for the users to prepare and to make the tea.

For allowing the users to easily prepare and to make the tea, some of the tea have been received or engaged in an envelope of a tea bag or tea bag package.

For example, U.S. Pat. No. 4,688,479 to Cunningham, and U.S. Pat. No. 7,147,879 to Stemmler disclose two of the typical tea bag packages each having a tea received or contained in an envelope.

However, the tea are contained within the envelope and may not be completely opened or stretched after being engaged in the hot water. In addition, most of the tea leaves contained within the envelope are chopped or cut tea leaves, and the users may not know what kind of tea leaves they are.

The present invention has arisen to mitigate and/or obviate the afore-described disadvantages of the conventional tea bag packages or devices.

### SUMMARY OF THE INVENTION

The primary objective of the present invention is to provide a tea cup device including a structure for allowing the tea to be completely opened or stretched and for blocking the tea and for preventing the tea from flowing into the mouth of the user while drinking the tea.

In accordance with one aspect of the invention, there is provided a tea cup device comprising a container including a chamber formed therein for receiving a tea, and a filter device disposed in the chamber of the container for separating the chamber of the container into a first compartment and a second compartment, and for receiving the tea in either of the first compartment or the second compartment, and for allowing the tea to be completely opened, and for blocking the tea.

The filter device may completely block the chamber of the container, or may partially block the chamber of the container. For example, the filter device may include a semi-circular screen member for partially separating the first and the second compartments of the container from each other, or a circular screen member for completely separating the first and the second compartments of the container from each other.

The filter device may include a flap extended from the semi-circular screen member, or may include a board secured to the semi-circular screen member.

The filter device includes a screen member, and a filtering paper material attached to the screen member. The filter device may be a filter cage. The filter device may include a screen member having at least one portion to be detached from the screen member.

The filter device may include two screen elements coupled together.

The filter device includes a cup-shaped structure having a number of apertures formed therein. The filter device includes at least one notch formed therein for engaging with at least one projection which is extended and provided in the chamber of the container.

The filter device includes at least one leg extended outwardly therefrom for engaging with the container. The container includes a mouth for pouring the tea.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a tea cup device in accordance with the present invention;

FIG. 2 is a perspective view of the tea cup device;

FIG. 3 is a perspective view similar to FIG. 2, illustrating the other arrangement of the tea cup device;

FIG. 4 is a plan schematic view illustrating the operation of the tea cup device as shown in FIG. 3;

FIG. 5 is a perspective view similar to FIGS. 2 and 3, illustrating the further arrangement of the tea cup device;

FIG. 6 is a perspective view similar to FIGS. 2-3 and 5, illustrating the still further arrangement of the tea cup device;

FIG. 7 is a cross sectional view of the tea cup device as shown in FIG. 6;

FIG. 8 is a perspective view similar to FIGS. 2-3 and 5-6, illustrating the still further arrangement of the tea cup device;

FIG. 9 is a partial exploded view illustrating the still further arrangement of the tea cup device;

FIG. 10 is a partial exploded view similar to FIG. 9, illustrating the still further arrangement of the tea cup device;

FIG. 11 is a perspective view similar to FIGS. 2-3, 5-6 and 8, illustrating the still further arrangement of the tea cup device;

FIG. 12 is a partial plan schematic view of the tea cup device as shown in FIG. 11;

FIG. 13 is a plan schematic view illustrating a filter device of the tea cup device;

FIG. 14 is a perspective view similar to FIGS. 2-3, 5-6, 8 and 11, illustrating the still further arrangement of the tea cup device having the filter device as shown in FIG. 13;

FIGS. 15, 16 are cross sectional views of the tea cup device taken along lines 15-15 and 16-16 of FIG. 14 respectively;

FIG. 17 is a partial exploded view illustrating the still further arrangement of the filter device for the tea cup device;

FIG. 18 is a partial exploded view similar to FIG. 17, illustrating the still further arrangement of the filter device for the tea cup device;

FIG. 19 is a further partial exploded view similar to FIGS. 9 and 10, illustrating the still further arrangement of the tea cup device;

FIG. 20 is a perspective view of the tea cup device as shown in FIG. 19;

FIGS. 21, 22, 23 are cross sectional views illustrating the operation of the tea cup device as shown in FIGS. 19-20; and

FIG. 24 is a further perspective view similar to FIGS. 2-3, 5-6, 8, 11, 14 and 20, illustrating the still further arrangement of the tea cup device.

### DETAILED DESCRIPTION OF THE PREFERRED EMBODIMENT

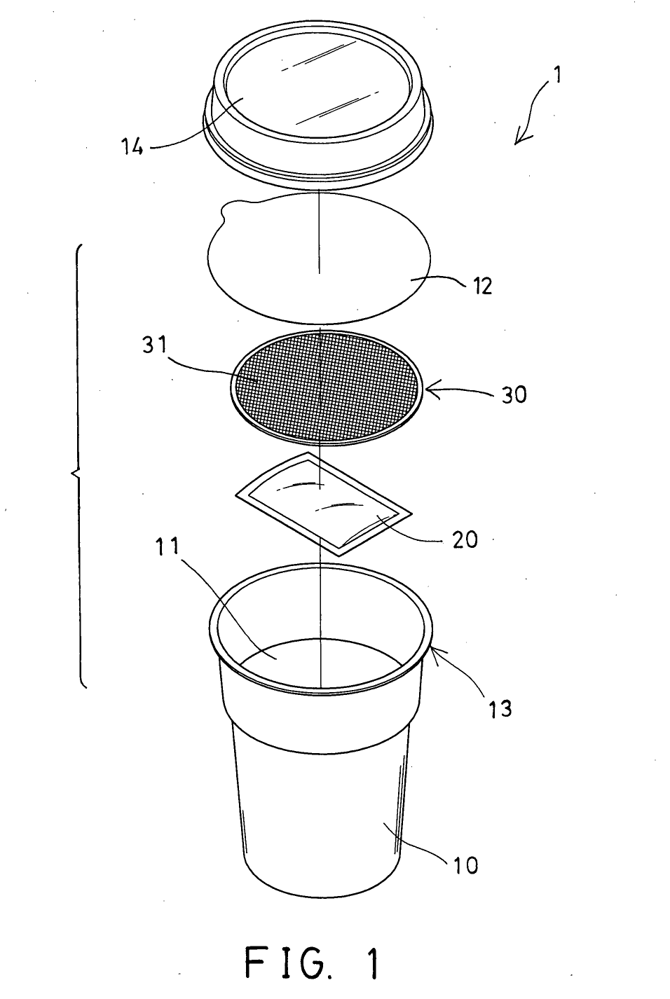

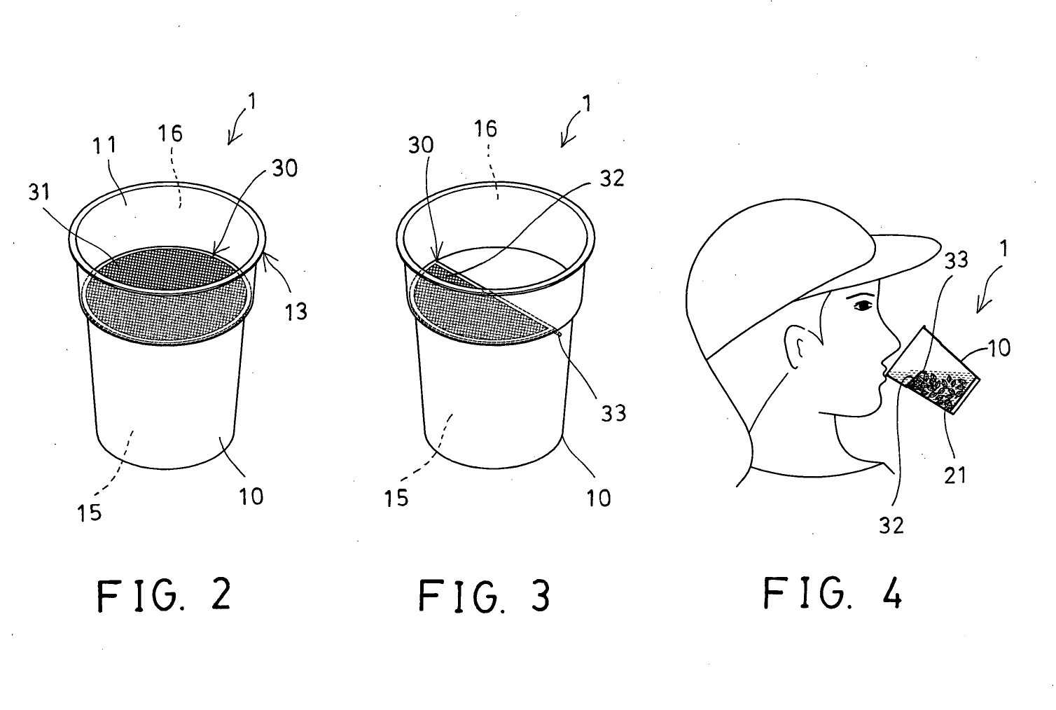

Referring to the drawings, and initially to FIGS. 1 and 2, a tea cup device 1 in accordance with the present invention comprises an outer cup body or container 10 including a chamber 11 formed or provided therein for receiving a tea or a tea bag package 20 or other drinkable materials, a membrane 12 selectively or optionally attached or secured or sealed onto the upper portion 13 of the container 10 for closing or sealing the chamber 11 of the container 10, and a cover 14 selectively or optionally attached or secured or engaged onto the upper portion 13 of the container 10 and/or the membrane 12, and a screen or filter device 30 disposed or engaged into the chamber 11 of the container 10 and for separating the chamber 11 of the container 10 into two separated compartments 15, 16, such as a lower compartment 15 and an upper compartment 16 or the like.

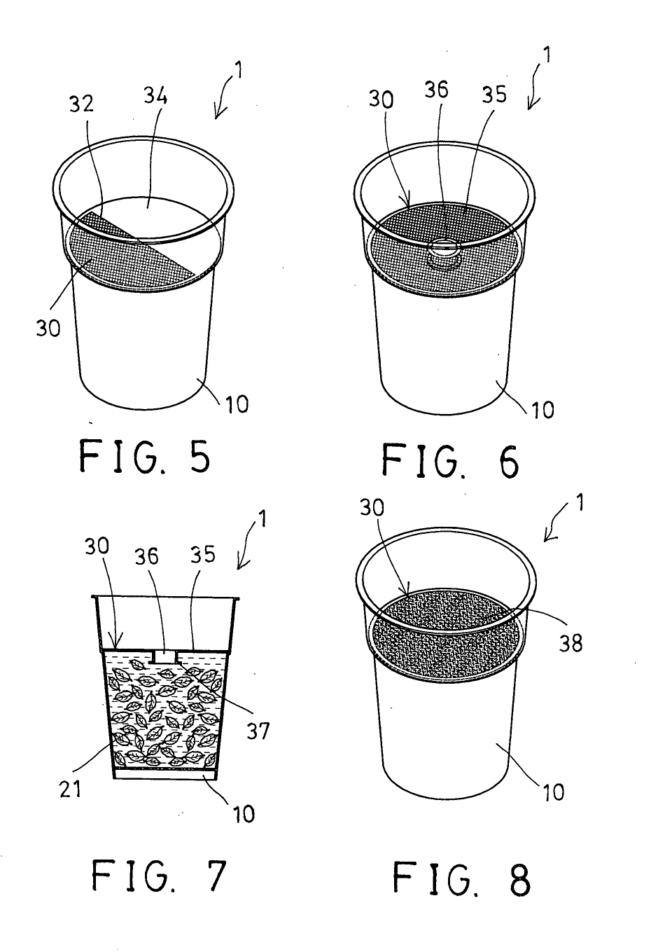

In operation, tea bag package 20 may be opened, or the tea 21 received or contained in the tea bag package 20 may be disposed or engaged into the chamber 11 of the container 10 (FIGS. 4, 7, 16) for tea making purposes and for allowing the tea to be completely opened or stretched. The filter device 30 may include a circular screen member 31 (FIGS. 1, 2) for completely separating the chamber 11 of the container 10 into two separated compartments 15, 16, or may include a semi-circular screen member 31 (FIGS. 3-5) for partially separating the compartments 15, 16 of the container 10 from each other, and may include a flap 33 extended or bent from the screen member 31 for blocking the tea 21 (FIG. 4) and for preventing the tea 21 from flowing into the mouth of the user while drinking the tea 21. The filter device 30 may further include a board 34 (FIG. 5) disposed or secured or provided on the other half of the screen member 31 for forming a circular shape or structure to the screen member 31.

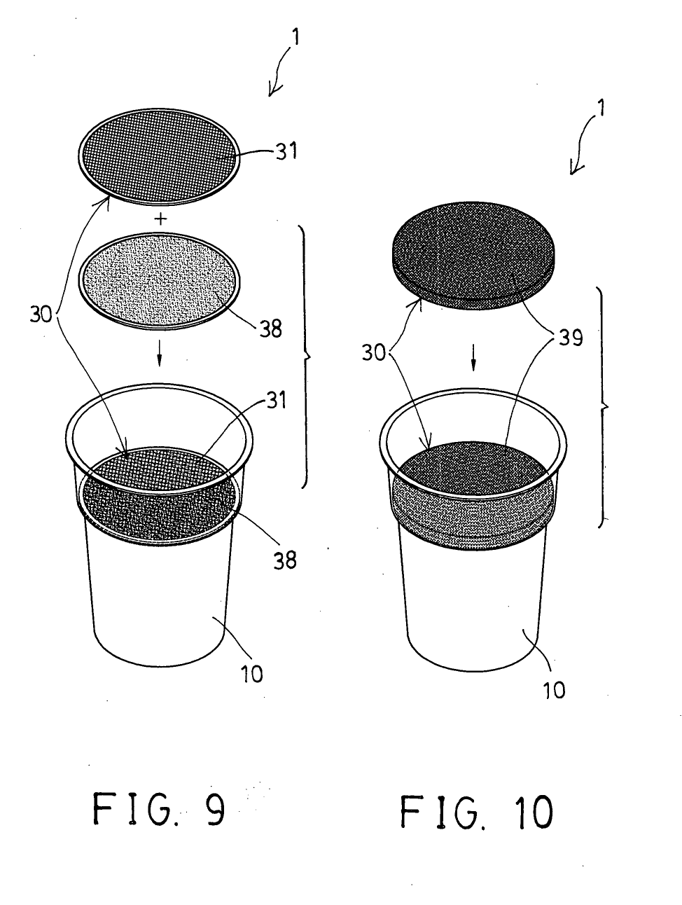

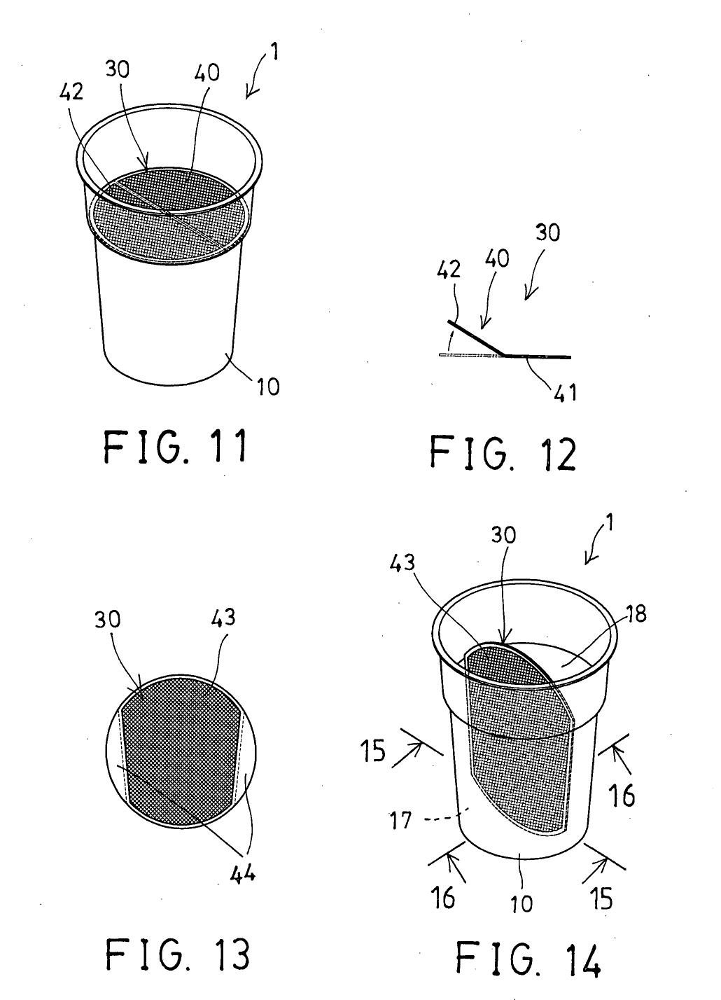

As shown in FIGS. 6 and 7, the filter device 30 may further include a circular screen member 35 having a center opening 36 formed therein for disposing or engaging the tea 21 into the chamber 11 of the container 10, and may include a flap 37 extended from the screen member 31 for blocking the tea 21 (FIG. 7) and for preventing the tea 21 from flowing into the mouth of the user while drinking the tea 21. As shown in FIG. 8, the filter device 30 may be made of a screen or filtering paper material 38, or may include a screen member 31 and a filtering paper material 38 attached to the screen member 31 as shown in FIG. 9, or may include a filter cage 39 disposed or engaged into the chamber 11 of the container 10 and for separating the chamber 11 of the container 10 into two separated compartments as shown in FIG. 10. As shown in FIGS. 11 and 12, the filter device 30 may include a screen member 40 having a stationary or fixed semi-circular screen element 41, and a foldable flap 42 to be partially or selectively opened.

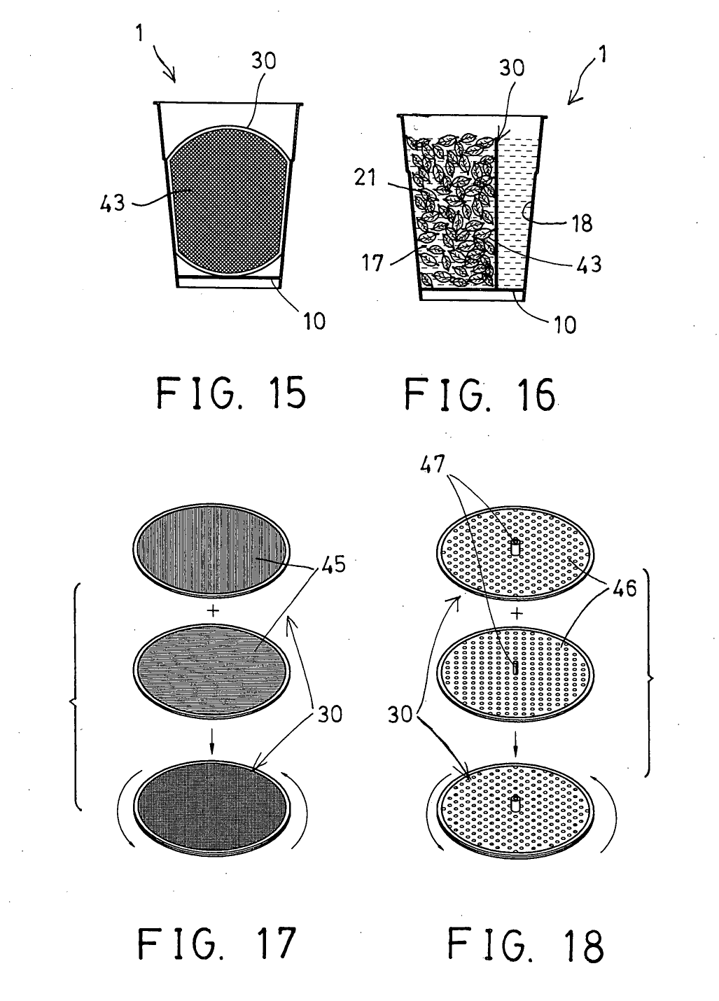

As shown in FIGS. 13-16, the filter device 30 may include a screen member 43 having one or more (such as two) portions 44 to be detached or disengaged from the screen member 43 for allowing the screen member 43 to be erectly or vertically disposed or engaged into the chamber 11 of the container 10 and for separating the chamber 11 of the container 10 into two separated side compartments 17, 18 (FIGS. 14, 16) and for blocking the tea 21 (FIG. 16) and for preventing the tea 21 from flowing into the mouth of the user while drinking the tea 21. As shown in FIG. 17, the filter device 30 may include two screen elements 45 disposed in different direction relative to each other, or may include two screen elements 46 coupled together with a pin joint 47 as shown in FIG. 18.

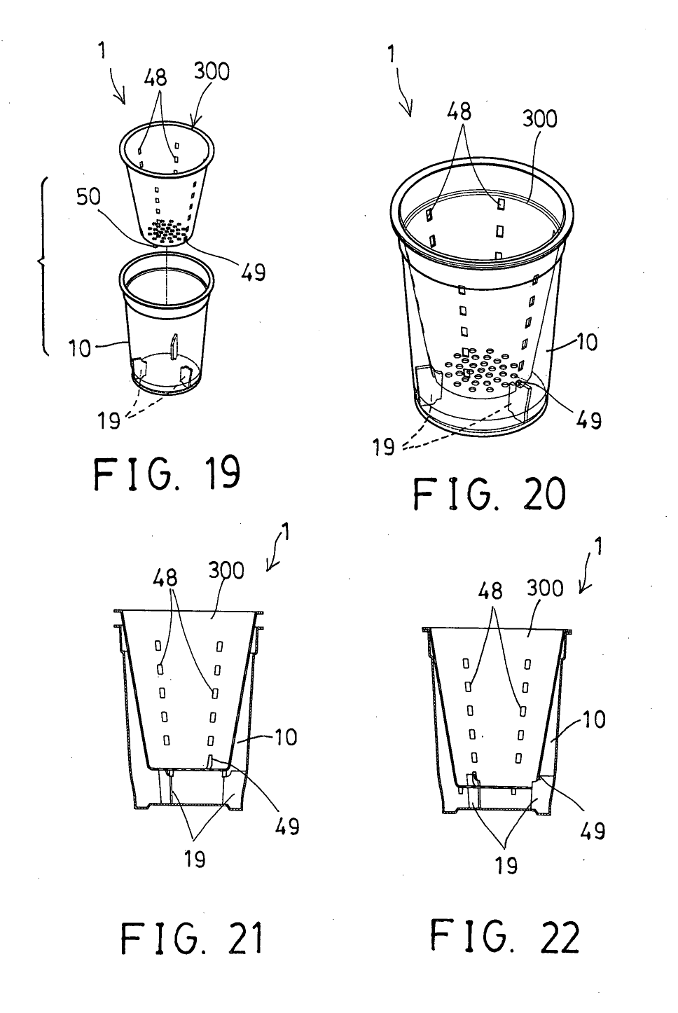

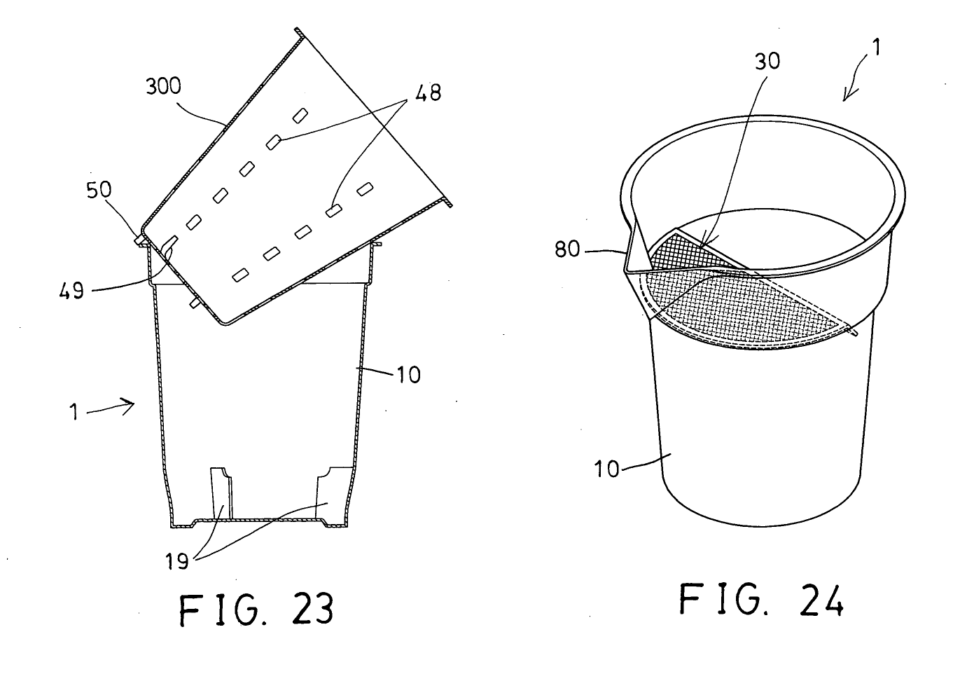

As shown in FIGS. 19-23, the filter device 300 may include a cup-shaped structure having a number of apertures 48 formed therein, and having one or more notches 49 formed in the bottom portion thereof for engaging with the corresponding projections 19 (FIGS. 20-22) that are extended or provided in the chamber 11 of the container 10, for suitably separating the cup-shaped filter device 300 from the container 10 and for allowing the tea 21 to be suitably opened or stretched in the space between the cup-shaped filter device 300 and the container 10, and the filter device 300 may include one or more legs 50 extended outwardly therefrom for engaging with the container 10 (FIG. 23), and for tiltably supporting the filter device 300 on top of the container 10. As shown in FIG. 24, the container 10 may include a mouth 80 for pouring the tea.

Accordingly, the tea cup device in accordance with the present invention includes a structure for allowing the tea to be completely opened or stretched and for blocking the tea and for preventing the tea from flowing into the mouth of the user while drinking the tea.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A tea cup device comprising:
a container including a chamber formed therein for receiving a tea, and
a filter device disposed in said chamber of said container for separating said chamber of said container into a first compartment and a second compartment, and for receiving the tea in either of said first compartment or said second compartment, and for allowing the tea to be completely opened, and for blocking the tea.

2. The tea cup device as claimed in claim 1, wherein said filter device completely blocks said chamber of said container.

3. The tea cup device as claimed in claim 1, wherein said filter device partially blocks said chamber of said container.

4. The tea cup device as claimed in claim 1, wherein said filter device includes a semi-circular screen member for partially separating said first and said second compartments of said container from each other.

5. The tea cup device as claimed in claim 4, wherein said filter device includes a flap extended from said semi-circular screen member.

6. The tea cup device as claimed in claim 4, wherein said filter device includes a board secured to said semi-circular screen member.

7. The tea cup device as claimed in claim 1, wherein said filter device includes a screen member, and a filtering paper material attached to said screen member.

8. The tea cup device as claimed in claim 1, wherein said filter device is a filter cage.

9. The tea cup device as claimed in claim 1, wherein said filter device includes a screen member having at least one portion to be detached from said screen member.

10. The tea cup device as claimed in claim 1, wherein said filter device includes two screen elements coupled together.

11. The tea cup device as claimed in claim 1, wherein said filter device includes a cup-shaped structure having a plurality of apertures formed therein.

12. The tea cup device as claimed in claim 11, wherein said filter device includes at least one notch formed therein for engaging with at least one projection which is extended and provided in said chamber of said container.

13. The tea cup device as claimed in claim 11, wherein said filter device includes at least one leg extended outwardly therefrom for engaging with said container.

14. The tea cup device as claimed in claim 1, wherein said container includes a mouth for pouring the tea.
